(19) United States
(12) Patent Application Publication
(10) Pub. No.: US 2003/0096213 A1
(43) Pub. Date: May 22, 2003

(54) Universal ultrasonic finishing instrument

(76) Inventors: Teresa R. Hickok, Bonita, CA (US); Clifford J. Ruddle, Santa Barbara, CA (US)

Correspondence Address: LEWIS, RICE & FINGERSH, LC, ATTN: BOX IP DEPT., 500 NORTH BROADWAY, SUITE 2000, ST LOUIS, MO, 63102, US

(21) Appl. No.: 09/996,410

(22) Filed: Nov. 20, 2001

(51) Int. Cl. A61C 3/08; A61C 1/10

(52) U.S. Cl. 433/119; 433/84; 433/165

(57) ABSTRACT

A dental tool for use with an ultrasonic transducer, the tool being substantially elongated and defined by a shaft having a proximal end with a coupling attachment at the proximal end for attachment to an ultrasonic transducer, and a distal end having a tip configured for performing excavation, finishing, removal and a dental polishing procedures, and a fluid passage extending from the proximal end to the distal end and exiting at a port at or proximate the tip.

### FIELD OF THE INVENTION

This invention relates generally to ultrasonic dental instruments and pertains more particularly to a special ultrasonic dental finishing tool.

### BACKGROUND

In the past decade, ultrasonic dental tools have come into greater use and are playing an ever-increasing role for drilling, cutting, shaping, cleaning and polishing teeth. Most of the devices used to prepare teeth have been powered by electric or air powered rotating motors. The tools useable with these powered prior art devices were limited to rotating drills, cutters, grinders and polishers. The ultrasonic powered dental tools of recent years have a different type of motion and have several advantages over prior tools for many applications. Among the advantages are that they are smaller, afford greater vision and precision and can be more easily manipulated in and around dental structures in the oral cavity.

The ultrasonic power units in use today have an entirely different type of motion than the rotary motion of air and electric motor powered units of the past. The motion imparted to the tool by an ultrasonic power unit is usually a very high frequency or velocity oscillation or reciprocation at the distal end of the tip of an otherwise stationery tool. The use of ultrasonic powered tools has resulted in the need for the development of entirely different types and sizes of tools than have existed in the past. While many tools have been developed and are available for use with ultrasonic power units, there is a need for additional tools designed and configured to perform new and different procedures.

Examples of ultrasonically powered instruments for dental use are disclosed in U.S. Pat. No. 4,019,254, issued Apr. 26, 1977 to Malmin, U.S. Pat. No. 5,094,617 issued Mar. 10, 1992 to Carr and PCT Publication WO 86/05967. With the exception of the first mentioned patent, all tools are formed with a shaft tapered to a point. More recent examples of improved tools are disclosed in the applicant's recently issued U.S. Pat. No. 5,836,765, issued Nov. 17, 1998, and U.S. Pat. No. 5,868,570 issued Nov. 12, 1998 to Hickok.

Ultrasonic tools, which have been developed in recent years, have begun to be used for many operations on teeth, bones, and soft tissue including dislodging and removal of dental material. These ultrasonic tools have been found to be particularly useful for scaling and cleaning. In many operations there is a need to clean and polish the furca and other areas of teeth for further treatment such as bonding restoratives to tooth structure. The cleaning and polishing of this area of a tooth can result in the reduction and often elimination of pockets by enhancing gum reattachment.

While many tools have been developed for use with ultrasonic transducers for dental work, it is apparent that many more procedures could be performed with the proper tools. Therefore, there is a need for improved ultrasonic dental tools formed of a suitable strong, flexible and durable heat resistant material with suitable configurations for performing various procedures in dentistry. There is particularly a need for improved ultrasonic dental tools having configurations than enable new and different procedures to be performed for removing and placing materials, precise removal of tooth structure and for cleaning and polishing teeth and supporting bone areas.

Periodontal disease affects many different areas in the oral cavity. These areas include the root area of the tooth, the bone in which the tooth is rooted and the gums around the tooth. Typical treatment involves removal of the diseased portion of the tooth or bone structure of these areas. This often involves curettage of the affected tissue, planing and smoothing of the root surfaces of the tooth and the surfaces of the bone. Pockets are often formed where an accumulation of calculus and other debris causes the gums to pull away from around the root and lower portion of the teeth. This must be cleaned away from the surface of the tooth and the surface smoothed in order for the gums to reattach to the tooth surface. In many operations there is a need to clean and polish the furca and other hard to reach areas of teeth for further treatment such as bonding restoratives to existing tooth structure. The cleaning and polishing of this area of a tooth can result in the reduction and often elimination of pockets by gum reattachment.

It would be desirable to have ultrasonic tools capable of placing or removing restorative materials, removing pulp stores, troughing for extra orifices, chasing calcified canals, precise elimination of tooth structure and finishing these areas of the teeth. Therefore, there is a need for an ultrasonic dental tool that has a tip configured for finishing and polishing certain areas of a tooth internally, exteriorly or bone. The present invention satisfies these needs and provides related advantages as well.

### SUMMARY OF THE INVENTION

A primary objective of this invention is to provide an improved ultrasonic dental tool having a tip that is formed for the cleaning, finishing and polishing of tooth areas and has a port for delivery of fluid through the tip to the work area.

In accordance with a primary aspect of the present invention, a dental finishing tool for use with an ultrasonic transducer comprises a substantially elongate tool defined by a shaft having a proximal end with attachment means at said proximal end for attachment to an ultrasonic transducer, and a distal end having a tip configured for performing a dental procedure, and a passage extending from the proximal end to the distal end and exiting at a port proximate the tip or through the center of the tip.

In one embodiment, the end of the tip has a spherical configuration and the shaft has a bend intermediate the proximal end and the distal end forming the tip extending at an angle to the shaft. In a further embodiment, the tip extends at an angle of between 70 and 85 degrees to the shaft away from the proximal end.

The invention also provides an ultrasonic dental tool with an adapter and connector sleeve. In further embodiments, the tool further comprises a quick change connector comprising an elongate shaft adapted for attachment to a hand piece of an ultrasonic generator, an expandable sleeve adapted for mounting on said shaft and extending into said socket, and a cam member on one of said sleeve and shaft operatively camming said sleeve into engagement with said mounting socket.

The invention further provides kits of multiple dental tools for use with an ultrasonic transducer. The kits comprise a plurality of substantially elongate tools defined by a shaft having a proximal end with attachment means at the proximal end for attachment to an ultrasonic transducer and a distal end having a tip configured for performing a dental polishing procedure and a passage extending from the proximal end to the distal end and exiting at a port proximate the center of the tip, wherein at least one tool has a spherical tip configuration.

### BRIEF DESCRIPTION OF DRAWINGS

The objects, advantages and features of this invention will be more readily appreciated from the following detailed description, when read in conjunction with the accompanying drawings, in which:

FIG. 1 is a side elevation view of an ultrasonic hand piece equipped with a contra angle dental tool constructed in accordance with a preferred embodiment of the invention;

FIG. 2 is an enlarged side elevation view of the dental tool of FIG. 1;

FIG. 3 is a side elevation view of an alternate embodiment of an ultrasonic dental tool;

FIG. 4 is a side part-sectional view of an alternate embodiment of an ultrasonic dental tool with the connector sleeve and adaptor attached;

FIG. 5 is a side part-sectional view of an alternate embodiment of an ultrasonic dental tool with the connector sleeve and adaptor attached;

FIG. 6 is a side elevation view of the ultrasonic dental tool of FIG. 2 in use;

FIG. 7 is a side elevation view of another embodiment of an ultrasonic dental tool in accordance with the invention; and

FIG. 8 is a side elevation view of a further embodiment of an ultrasonic dental tool in accordance with the invention.

### DETAILED DESCRIPTION OF PREFERRED EMBODIMENTS

The present invention is described with reference to preferred embodiments of the invention as illustrated in the drawings. While this invention is described in terms of the best mode for achieving this invention's objectives, it will be appreciated by those skilled in the art that variations may be made in view of these teachings without deviating from the spirit or scope of the invention.

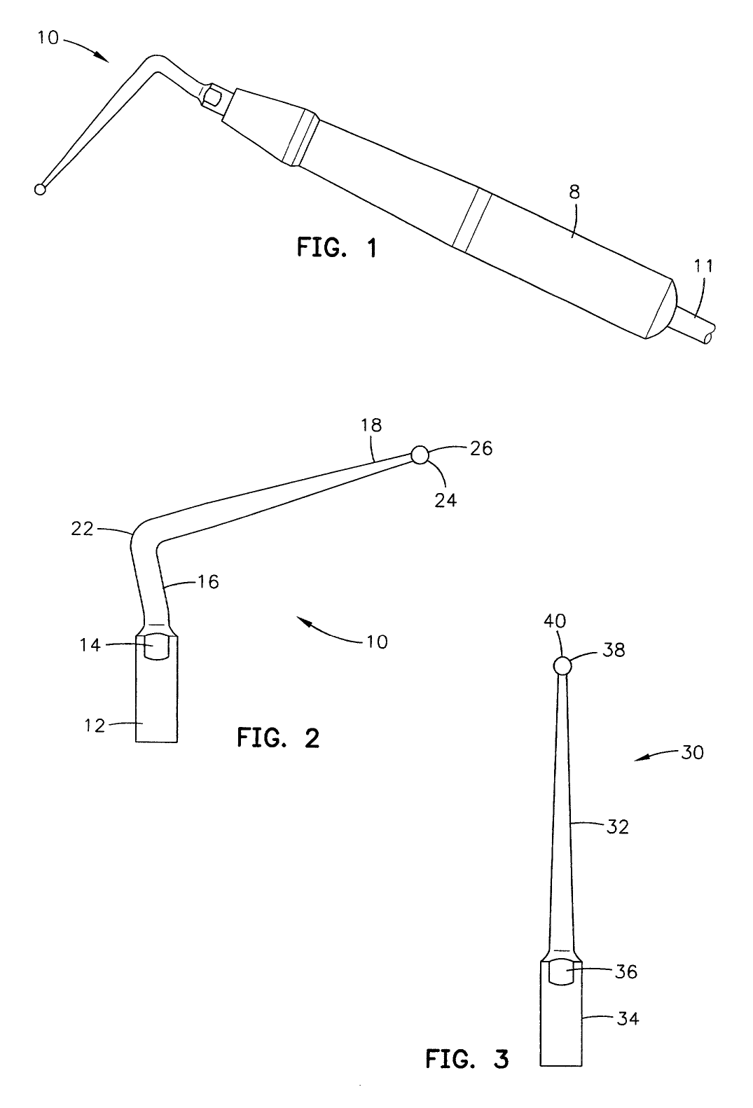

Referring to FIG. 1 of the drawings, an ultrasonic hand piece, designated generally by the numeral 8, is illustrated with an exemplary embodiment of a tool in accordance with the invention designated generally at 10, for dental operations shown attached to one end of the hand piece. An ultrasonic transducer or motor is mounted in the hand piece and is connected by a conductor within a line 11 to a converter box (not shown). The line 11 may also contain a water line or tube for conveying water or other fluids to the working tip. The tool 10 may also preferably be formed with means to get water or fluid to the working end or tip of the tool. The ultrasonic transducer (not shown) within the hand piece is connected to a shaft (not shown) that extends from the front of the hand piece to which the tool is attached by a suitable detachable connection.

The tool 10 illustrated in FIGS. 1 and 2, is designed primarily for performing the removal of restoratives, removal of post, breaking up of core materials, cleaning, finishing and polishing operations on teeth and bones. The tool 10 is designed and configured with a tip having a rounded surface configured and finished for performing a variety of dental procedures. The tool is also provided with a passage to convey water or other fluid to the working tip or surface of the tip. As used herein, the “working tip” refers to that part of the tool typically at the outer or distal end thereof adapted to be engaged in contact with the tooth or tissue for performing work. The tools are constructed with the shaft near the tip in a range of sizes from on the order of about 0.036 to 0.040 inch in diameter with the tip about 0.060 inch in radius. For this reason the tools are preferably constructed of a good grade of stainless steel alloy, and may also be constructed of other suitable materials such as a strong medical grade titanium alloy.

The tool, as illustrated in FIGS. 1 and 2, contra angled proximally and comprised of an elongated shank or shaft 16 having connecting means 12 at one or a proximal end for detachable attachment to a hand piece of an ultrasonic power unit. Connecting means 12 is shown in the form of a threaded socket for threadably mounting on the end of a shaft or stud (not shown) on the end of the hand piece. The connecting means may also be in the form of a threaded stub designed to threadably engage and connect to a socket on a hand piece. The connector end of the tool is formed with a flat 14 on each side for engagement by a wrench or the like for rotating the tool and threadably tightening and loosening the tool.

As shown in FIG. 2, tool 10 is preferably formed with an elongated tapered shank or shaft having a proximal portion or contra angled end 16 and a distal portion or end 18 with a fairly sharp bend 22 between the ends. The proximal portion 16 is offset or angled from the axis of the connector. The curve or bend 22 is preferably closer to the connector end than the working tip end. This combination forms a contra angle that positions the tip for ease of positioning and manipulation by the user. The distal portion of the shaft of the tool is substantially straight and tapers down in diameter from the bend to the working tip. The tool has a working tip 24 that preferably has a spherical configuration and a diameter that exceeds that of the shaft adjacent the tip. Spherical tip 24 is preferably larger in diameter than shaft 16 by factor of up to about two. The tool is preferably provided with a fluid passage extending the length thereof from the connector end to an outlet port 26 at the working tip. The fluid outlet may be directly at the tip or spaced a slight distance from the tip.

The shaft is bent so that the tapered tip portion is curved or bent at 22 in a direction away from the axis of the shank or shaft portion 16 at an angle of preferably about 70° to 85°, extending away from the proximal end. However, it is also contemplated herein that said angle could be between 45° and 90° as well. The bends in the shaft may be greater or less than those illustrated and are designed to position the working tip at a convenient and comfortable working position relative to the hand piece for the user. It will be appreciated from the present disclosure that the selection of the angle is to some extent dependent on the particular use of the tool and also individual user preferences. In any event it is to enable the user to properly position the working tip as necessary within the oral cavity. Accordingly, the present invention contemplates that the tip may be at any angle with respect to the shaft thereto, or it may be collinear with the shaft, the selection of which is dependent on the location that the particular procedure is being performed.

Referring to FIG. 3, an example of a tool with a collinear tip and shaft is illustrated and designated generally at 30. As illustrated therein, the tool designated has an elongated tapered shaft 32 with a connector 34 having wrench flats 36 at a proximal end and a spherical tip 38 at the distal end of the tool. The tool is preferably formed with a fluid passage extending the length thereof with an outlet port 40 at the tip. The fluid passage may be formed in any suitable well-known manner or may be formed the novel manner as disclosed in applicants co-pending application Ser. No. 09/326,046 filed Jun. 4, 1999.

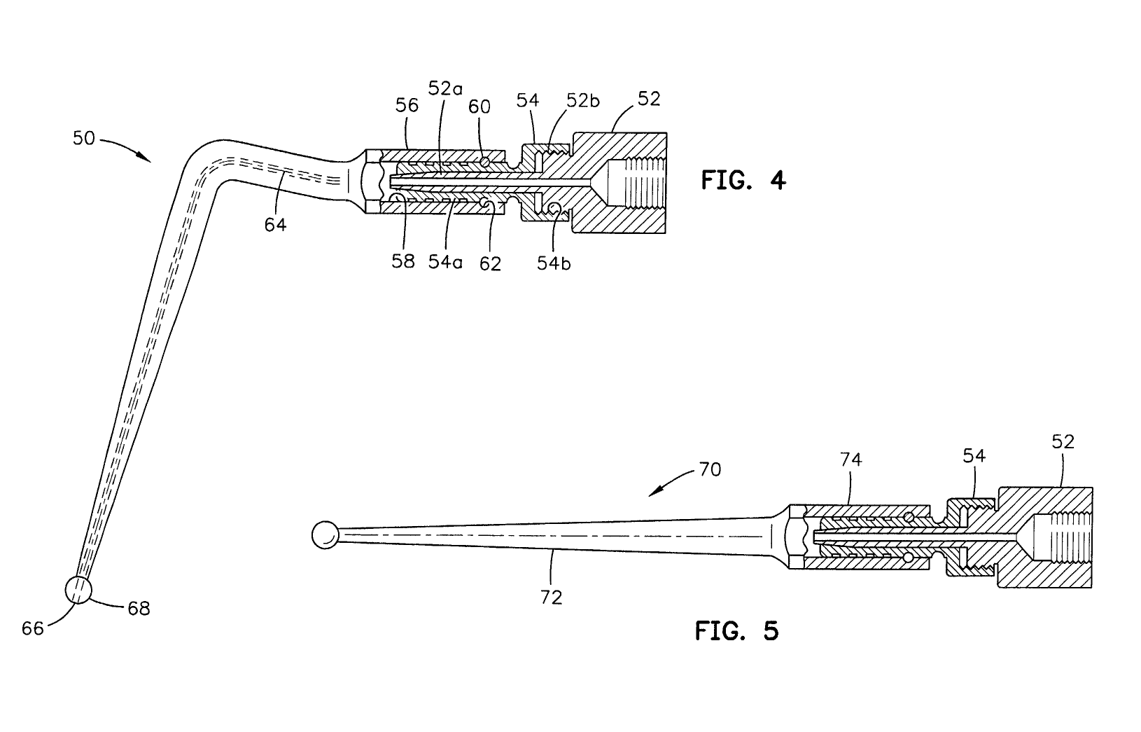

Referring now specifically to FIG. 4, an ultrasonic dental tool designated generally at 50 having a configuration substantially like that of FIGS. 1 and 2, is shown in combination with a quick connect adapter assembly. The quick connect assembly comprises a mounting stud 52 having a threaded socket for mounting on a threaded stud of a hand piece. The mounting stud includes an elongated forwardly extending tapered shaft 52a on which is mounted a forwardly extending expandable sleeve portion 54a of a sleeve member 54. The tool has a hub 56 with a coaxial generally cylindrical mounting socket 58, which receives and is gripped by the expandable sleeve portion 54a. An annular groove 60 is provided or formed in the inner cylindrical mounting socket bore of the tool to receive an elastomeric o-ring 62 for sealing when the socket is forced onto the sleeve portion 54a. As the sleeve 54 is threaded onto the threaded portion of stud 52, the expandable sleeve portion 54a expands to grip the interior surface of the bore 58. This connection enables the quick attachment and removal (i.e. quick change) of tools. The shaft of the tool 50 is substantially like that of FIG. 2, with a central bore 64 communicating with a port 66 in the spherical tip 68.

FIG. 5 shows an alternative embodiment of an ultrasonic dental tool 70 with an elongated substantially straight tip or shaft 72 substantially like that of FIG. 3. The tool 70 is provided with a connector. This connector enables the tool to be used in conjunction with the quick-change adapter as described in connection with the prior embodiment illustrated in FIG. 4.

Referring to FIGS. 4 and 5, in operation, the sleeve 54 is mounted on the shaft 52 with threads 54b engaging threads 52b, but backed off from the threads 52b on the until the forward conical or cam portion 54a thereof backs off from the forward conical shape cam 52a of the member 52. It will be apparent that only one of the cam surfaces 52a and 54a may be required. In other words either one of the cams may be present and the other absent. The hub of a tool is placed on the outer surface of the sleeve until the annular groove snaps over the o-ring 60. Thereafter the sleeve 54 is rotated by hand threading the threads 54a onto the threaded portion 52a until the sleeve is cammed and expands into tight engagement with the internal bore 58 (FIG. 4) of the hub of the tool. This adapter assembly enables the quick detachable connection and removal of tools on a hand piece of an ultrasonic generator.

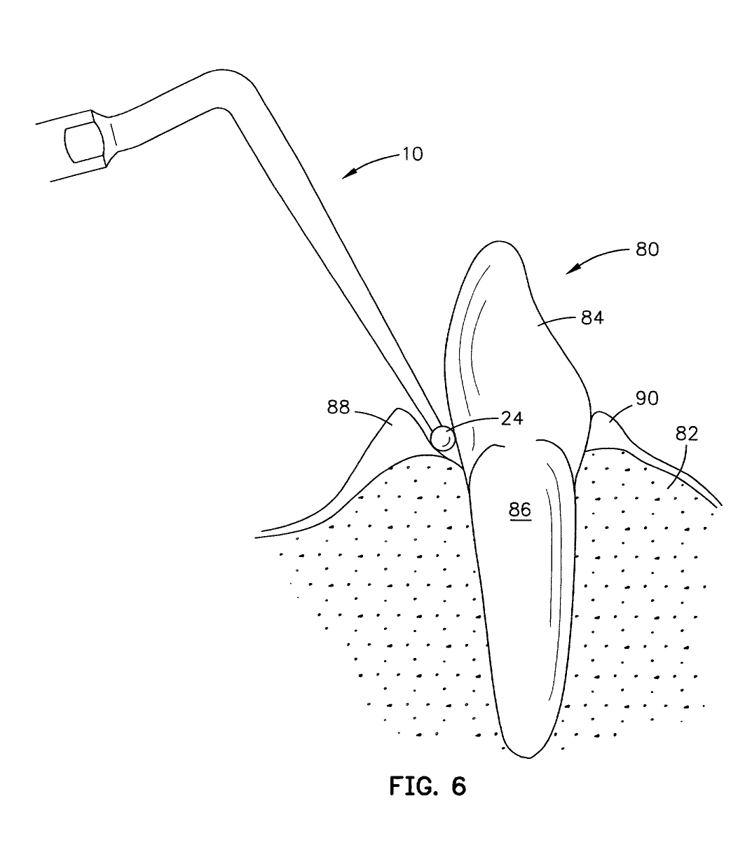

Referring to FIG. 6, the tool 10 of FIG. 1 is shown in use on an area around the base of the crown of a tooth. A tooth designated generally at 80 is shown mounted in a bone 92. The tooth is shown with a crown portion 84 and a root portion 86 extending into and seated in the bone 82. Gums 88 and 90 are shown covering the bone around the base of the tooth. The gums in a healthy environment are normally adhered to the base of the tooth. However gums frequently pull away from the base of the tooth and form pockets where calcium deposits are normally formed. When calcium deposits are removed, the areas of the tooth must be cleaned and polished to enable the gums to reattach to the base of the tooth. The tools of the present invention are particularly adapted for performing this task. The rounded tip 24 of the tool 10 engages the surface of the tooth area to be polished and moves at high frequency under the power of the ultrasonic transducer and polishes the surface area engaged. The tip may have a very fine abrasive surface or it may have a relative smooth polished surface. The movement of the tip on the surface of the tooth or bone area cleans and polishes the surface.

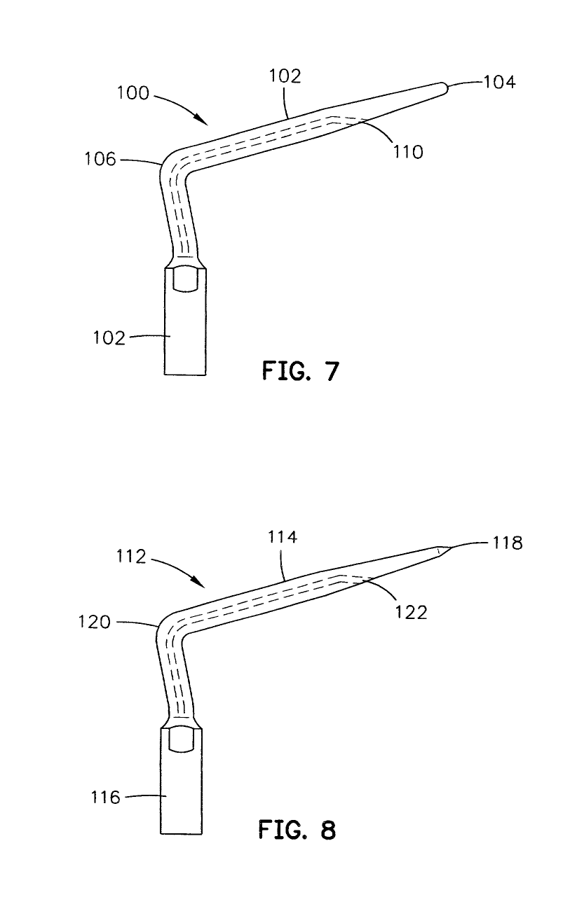

Referring to FIG. 7, a tool designated generally at 100 is illustrated and preferably formed similar to the FIG. 2 embodiment. The tool is formed with an elongated tapered shank or shaft 104 having a proximal portion or end 102 with a connector and a distal working tip or end 104 and a fairly sharp bend 106 between the ends. A proximal portion of the shank at the connector is offset or angled from the axis of the connector up to the bend 106. The curve or bend 106 is preferably closer to the connector end than the working tip end, and as in prior embodiments, forms a contra angle that positions the tip for ease of positioning and manipulation by the user. The distal portion of the shaft of the tool is substantially straight and tapers down in diameter from the bend to the working tip 104 that preferably has a semi-spherical configuration and a diameter that is substantially the same as that of the shaft adjacent the tip. The tool is preferably provided with a fluid passage extending substantially the length thereof from the connector end to an outlet port 110 positioned at or near the working tip.

The shaft is bent so that the tapered tip portion is curved or bent at 106 in a direction away from the axis of the shank or shaft portion at an angle of between 45° and 90° and preferably about 70° to 85°, extending away from the proximal end. This configuration positions the working tip at a convenient and comfortable working position relative to the hand piece for the user. The selection of the angle is to some extent dependent on the particular use of the tool and also individual user preferences to enable the user to properly position the working tip as necessary within the oral cavity. Accordingly, the present invention contemplates that the tip may be at any angle with respect to the shaft thereto, or it may be collinear with the shaft, the selection of which is dependent on the location that the particular procedure is being performed.

Illustrated in FIG. 8, is a tool 92 configured similar to the FIG. 7 embodiment with an elongated tapered shank or shaft having a proximal portion or end 116 with a connector and a distal working portion or end 118. As in the prior embodiment, a fairly sharp bend 120 is formed between the ends. The proximal portion adjacent the connector as, in prior embodiments, is offset or angled from the axis of the connector. The curve or bend 120 is preferably closer to the connector end than the working tip end, and as in prior embodiments, forms a contra angle that positions the tip with respect to the hand piece for ease of positioning and manipulation by the user. The distal portion of the shaft of the tool is substantially straight and tapers gradually down in diameter from the bend to a position where it tapers down sharply in a conical taper to a point at the working tip. The tool is preferably provided with a fluid passage extending substantially the length thereof from the connector end to an outlet port 122 at the working tip. The fluid outlet may be directly at the tip or spaced a slight distance from the tip as shown.

The shaft is configured, as in previous embodiments, so that the tapered tip portion is curved or bent in a direction away from the axis of the shank or shaft portion at an angle of between 45° and 90° and preferably about 70° to 85°. The working tip is thereby positioned at a convenient and comfortable working position relative to the hand piece for the user. Accordingly, the present invention contemplates that the tip may be at any angle with respect to the shaft thereto, or it may be collinear with the shaft, the selection of which is dependent on the location that the particular procedure is being performed.

The tools of the invention may be constructed of a good medical grade of stainless steel or, any other suitable material such as a titanium alloy of a medical grade. Suitable stainless steels include 13-8Mo and 17-4PH. As used herein, a “medical grade alloy” refers to a material that may be used in contact with food and with a patient's body without undergoing a chemical reaction. A particularly suitable titanium alloy is identified as 6AL/4V ELI & CP Grade 4, which is available from President Titanium of Hanson, Mass. This alloy has been demonstrated to be sufficiently hard, durable and flexible to resist breakage under normal use. It has also been found to withstand heat for short durations of use in the absence of a cooling fluid without burning or melting. Tools can be made smaller with the titanium alloys than have ever been achieved before with the stainless steels. They can be made very small with very small tips that will withstand the rapid buildup of heat normally encountered in orthodontal applications, especially when ultrasonic transducers are used. The small and thin tip design affords greater access to confined areas.

Those skilled in the art will understand that the invention provides great flexibility to the user in being able to deliver a stream of fluid to the working area through the tip. For example, a host of chemicals can be delivered at precise points or to specific areas of the oral cavity in selected dosages. This opens up various methods and procedures capable of being performed with the invention. Although water may be delivered to the work area at the spherical tip, for cooling the tool or tooth, or for rinsing away debris, additional, various chemicals or even drugs can be delivered to the working area. For example, antibiotic or antiseptic solutions, or even fluoride solutions can be directed at a specific portion of tooth at or below the gum-line. For example, as shown in FIG. 4, fluid passage 64 extends through the tool and terminates at port 66 at the spherical tip 68. This allows fluid to be delivered as close as possible to the working point or contact point of the tool with the tooth or tissue.

Although it is contemplated herein that port 66 (FIG. 4, for example) is proximate the center of the tip, it is understood that the port can be at any other suitable location on or near the spherical tip, so long as fluid is conveniently delivered at or near the working or contact surface between the spherical tip and the tooth.

In the primary polishing application of the present invention the tip of the tool will preferably be smooth to provide a high degree of polish to the tooth. If desired, a modification may be made wherein the ultrasonic dental tip is provided with a roughened area of tip 24. The roughened area provides a coarse abrasive surface that will cut along any part of the roughened surface. The abrasive surface provides for additional manners for dental cutting or polishing.

Preferably the roughing of the surface is performed by sand blasting the desired area with a microetcher or microblaster using approximately 400 grit powder. A suitable choice for such a sandblaster is provided by Danville Engineering Inc., of Danville Calif., and is available by the model name of “S-2 Precision Microsandblaster.” It is preferable to operate the sandblaster by supplying pneumatic pressure of about 60 to 120 pounds per square inch, although it will be apparent to one skilled in the art that any suitable hydraulic pressure could be provided.

The roughening of the tool surface is preferably carried out after any hardening and before any coating process. The roughening is a less expensive process than coating with diamond particles. It also enables the construction and preparation of more precise and accurate tips. However, if desired, coating the tool surface with diamond particles can also be performed.

Thus, the tools of the present invention are useful for removing plaque or sub gingival scale. For example, in periodontal, the sub gingival scale must be removed and the cementum must be planed and polished to a smooth and clean surface. This is necessary for optimum reattachment of the gingival to the tooth. Using the tools herein, the patient is subjected to less discomfort, and the procedure can be performed more quickly, efficiently and effectively.

While the tool described herein is particularly adapted for dental polishing, and removing sub-gingival scale, for example, it should be appreciated that the invention is not limited to those uses alone. For example, if desired, the tool may be used in microdental surgical techniques where a gradual or less aggressive removal of dental materials, tooth structure or bone material is desired. This would be particularly beneficial in a root canal procedure where the surgeon wants to remove the pulp, bacteria, dentin or various dental materials from the pulp cavity but does not want to perforate. Those skilled in the art understand that the tools herein may be used for other procedures as well. The tool as shown may be detachably connected to an ultrasonic vibrator or transducer (not shown) of generally well-known conventional construction for carrying out micro dental surgical and nonsurgical procedures.

While the invention is illustrated and described by means of specific embodiments, it is understood by those skilled in the art that numerous changes and modifications may be made herein without departing from the spirit and the scope of the invention. Accordingly, the invention is limited only by the following claims.

I claim:

1. A dental tool for use with an ultrasonic transducer, the tool comprising:
a substantially elongate tool defined by a shaft having a proximal end with attachment means at said proximal end for attachment to an ultrasonic transducer, and a distal end having a tip configured for performing a variety of dental procedures; and
a passage extending from said proximal end to said distal end and exiting at a port proximate the end of said tip.

2. The tool of claim 1, wherein the end of said tip has a spherical configuration.

3. The tool of claim 2, wherein said spherical tip is larger in diameter than the diameter of said shaft.

4. The tool of claim 1, wherein said shaft tapers down from said attachment means to said tip.

5. The tool of claim 1, wherein said shaft has a bend intermediate said proximal end and said distal end so that said tip extends at an angle to said shaft.

6. The tool of claim 5, wherein said tip extends at an angle of between 70 and 85 degrees to said shaft, away from said proximal end.

7. The tool of claim 5, wherein said tip extends at an angle of between 45 to 90 degrees to said shaft, away from said proximal end.

8. The tool of claim 1 wherein the end of said tip has a semi-spherical configuration.

9. The tool of claim 1 wherein the end of said tip has a conical configuration tapering to a pointed tip.

10. The tool of claim 1, wherein said tool is comprised substantially uniformly throughout of titanium alloy.

11. The tool of claim 10, wherein said titanium alloy is about 5.5% to about 6.5% aluminum and about 3.5% to 4.5% vanadium.

12. A dental tool for use with an ultrasonic transducer, the tool comprising:
a substantially elongate tool defined by a shaft having a proximal end with attachment means at said proximal end for attachment to an ultrasonic transducer, and a distal end having a tip configured for performing a variety of dental procedures; and
a passage extending from said proximal end to said distal end and exiting at a port proximate the center of the end of said spherical tip, wherein said shaft has a bend intermediate said proximal end and said distal end forming said spherical tip extending at an angle to said shaft.

13. The tool of claim 12, wherein the end of said tip has a spherical configuration.

14. The tool of claim 13, wherein said spherical tip is larger in diameter than the diameter of said shaft.

15. The tool of claim 12 wherein the end of said tip has a semi-spherical configuration.

16. The tool of claim 12, wherein said shaft tapers down from said attachment means to said tip.

17. The tool of claim 10, wherein said tip extends at an angle of between 45 to 90 degrees to said shaft, away from said proximal end.

18. The tool of claim 10 comprised substantially uniformly throughout of titanium alloy.

19. The tool of claim 13, wherein said titanium alloy is about 5.5% to about 6.5% aluminum and about 3.5% to 4.5% vanadium.

20. The tool of claim 1, wherein said tool has a hub with a generally cylindrical mounting socket and further comprising a quick connect connector comprising:
an elongate shaft adapted for attachment to a hand piece of an ultrasonic generator;
an expandable sleeve adapted for mounting on said shaft and extending into said socket; and
a cam member on one of said sleeve and shaft operatively camming said sleeve into engagement with said mounting socket.

21. The tool of claim 15, wherein said shaft and said sleeve have threads for moving said sleeve axially along said shaft to affect said camming.

22. The tool of claim 16, wherein:
said sleeve has an annular circumferential member thereon; and
said socket has a circumferential groove for engaging said circumferential member for positioning said socket.
